(19) United States
(12) Patent Application Publication
(10) Pub. No.: US 2016/0377472 A1
(43) Pub. Date: Dec. 29, 2016

(54) FLUID LEVEL VERIFICATION APPARATUS

(71) Applicant: Oil-Rite Corporation, Manitowoc, WI (US)

(72) Inventor: MICHAEL J. WECH, Manitowoc, WI (US)

(21) Appl. No.: 14/754,191

(22) Filed: Jun. 29, 2015

(51) Int. Cl. G01F 23/02

(52) U.S. Cl. CPC G01F 23/02

(57) ABSTRACT

An improved fluid level verification apparatus which may be manufactured or otherwise fabricated as a kit and assembled at a remote location for use on liquid filled containers and configured to reduce inherent mechanical stresses on the inspection tube and resists leakage due to environmental, chemical, thermal, or mechanical, expansion cycles using internal grooves and entrapped o-rings sheathed into multi-faced end blocks in a symmetrical configuration.

### BACKGROUND OF THE INVENTION

1. Field of Invention

The present invention relates generally to a fluid level verification apparatus which is operable to measure the amount of fluid present in an object of interest, such as a tank, machine, or other article of manufacture, and more specifically, to an apparatus which may be manufactured or otherwise fabricated as a kit and assembled at a remote location for use on particular machines or in manufacturing processes; and which minimizes the number of components required; and further to a fluid level verification apparatus which reduces mechanical, thermal and chemical stresses on the apparatus.

2. Description of the Prior Art

The prior art is sated with examples of fluid level verification apparatuses which provide a means for visually verifying or otherwise discovering the fluid levels in an object of interest, such as manufacturing machinery, fluid holding tanks, or other similar assemblies. For example, in certain industrial processes or in certain machines or other articles of manufacture, it is important that particular fluids, such as lubricants, coolants, hydraulic fluids, or other fluid components, be stored in tanks and periodically dispensed from such tanks. Prior art fluid verification devices have typically included a transparent tube or inspection window, which is connected in particular relation to the holding tank, and which provides a quick and convenient means by which an observer may visually verify the level of the fluid present.

While the prior art devices have operated with success, they have been unsatisfactory in several respects.

Gruett U.S. Pat. No. 5,323,653 provides a detailed background of the prior art and describes a fluid level verification apparatus that can be fabricated as a kit and assembled at a remote location. Gruett contemplates an inspection tube having an interior conduit dimensioned to create an interference fit with an o-ring used to hermetically seal the inspection tube to an end member. The Gruett apparatus requires a separate seal on the outer diameter of its glass inspection tube to complete a hermetic seal.

Jackson U.S. Pat. No. 4,345,468 describes a double tube liquid site monitor which incorporates grooving and o-rings to isolate the inspection tube from the environment. However, the Jackson invention is complex and cumbersome, as it requires numerous parts to protect the inspection tube from the stresses caused by the environment. Moreover, the sealing function of the grooves are limited to the insert ends thus requiring the o-rings to rest against the internal and external surfaces of the inspection tubes that have no such grooves and the problem of mechanical stress induced by the assembly of the inspection tubes to mating components is not contemplated.

Evans U.S. Pat. No. 4,050,305 describes an external shield bracket for a fluid flowmeter. The fluid of interest flows through a precision glass tube. An operator is protected from accidental explosion of the inspection tube due to fluid pressure by a protective transparent cover mounted on a u-shaped channel bracket. The Evans invention uses many parts, but fails to protect the inspection tube from the environment. Said transparent cover and mounting bracket do not form a hermetic closure for the inspection tube contained therein.

Gruett U.S. Pat. No. 3,886,796 describes a liquid level gauge with a rigid transparent plastic inspection tube with o-rings seated in grooves located in the end members. The Gruett invention induces mechanical stress on the inspection tube because Gruett did not contemplate o-ring grooves on the exterior or interior portions of the inspection tube. Further, because the ends of the inspection tube are restricted and nested in end members, stresses related to thermal, environmental and chemical expansion cycles are exasperated.

Lyden U.S. Pat. No. 3,540,276 describes a fluid level gauge. The Lyden invention uses an o-ring seal nested in an end member, communicating with the adjacent end of a site tube. Fluid leaks are minimized by placing the glass site tube in compression with the o-ring seal nested in the respective end member. The glass site tube is required because the Lyden invention requires compressive force on the tube. Thus, the design creates inherent mechanical stress and without utilizing the glass site tube adopts poorly to thermal, environmental and chemical expansion cycles and therefore would be susceptible to leakage.

Wech, U.S. Pat. No. 6,532,815 describes a fluid level verification apparatus. The Wech invention uses an o-ring seal and internal grooves on the respective end member. The plastic site tube is machined to communicate with an end member nipple and aperture, which limits the amount of fluid to flow through the conduit.

In addition to the foregoing, many of the prior art devices are cumbersome and otherwise complex in their overall design, thereby increasing the cost to manufacture, decreasing the reliability and making them difficult to maintain. Further, the prior art is replete with designs that inadequately address the often conflicting requirements of resisting fluid leaks and protecting the inspection tube from mechanical, environmental, thermal and chemical stresses.

### SUMMARY OF THE INVENTION

Therefore, it is an object of the present invention to provide an improved fluid level verification apparatus.

Another object of the present invention is to provide fluid level verification apparatus which can be fabricated as a kit and remain assembled through subsequent handling, transport, and shipping operations.

Another object of the present invention is to provide a fluid level verification apparatus which can be manufactured to provide convenient means to efficiently assemble the apparatus at a remote location for use with a wide range of devices and other objects of interest without waste of effort, time or motion expended on reassembly of the apparatus. Specifically, an object of the present invention is to prevent inadvertent dislodging of particular components comprising the invention, such as the bolts in relation to the blocks.

Another object of the present invention is to protect the transparent inspection tube from mechanical stress during manufacture, transport, handling, shipping, assembly.

Another object of the present invention is to provide for easy installation of the subject fluid level verification apparatus, to a tank, vessel, container or other object of interest.

Another object of the present invention is to provide a means to reduce or eliminate stress on the apparatus, whether such stress is due to thermal, mechanical, environmental or chemical agents acting upon the apparatus.

Another object of the present invention is to provide a means to reduce or eliminate leaking of the fluid flowing through the apparatus.

Another object of the present invention is to provide a means to substantially increase the flow of liquid through the apparatus.

These and other objects of the invention will become apparent in the descriptions and drawings that follow.

### BRIEF DESCRIPTION OF THE DRAWINGS

FIG. 1 is an isometric view of a fluid level verification apparatus according to the present invention.

FIG. 2 is an exploded isometric view of the fluid level verification apparatus shown in FIG. 1.

FIG. 3 is an exploded isometric view of a supporting block shown in FIG. 1 according to the present invention.

FIG. 4 is an isometric view of a bolt shown in FIG. 1 according to the present invention.

FIG. 5 is a cross-sectional view of an inspection tube shown in FIG. 1 according to the present invention.

FIG. 6 is a cross-sectional view of the fluid level verification apparatus along line 6-6 in FIG. 1.

FIG. 7 is a cross-sectional view of the fluid verification apparatus along line 6-6 in FIG. 1.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structure. While the preferred embodiment has been described, the details may be changed without departing from the invention, which is defined by the claims.

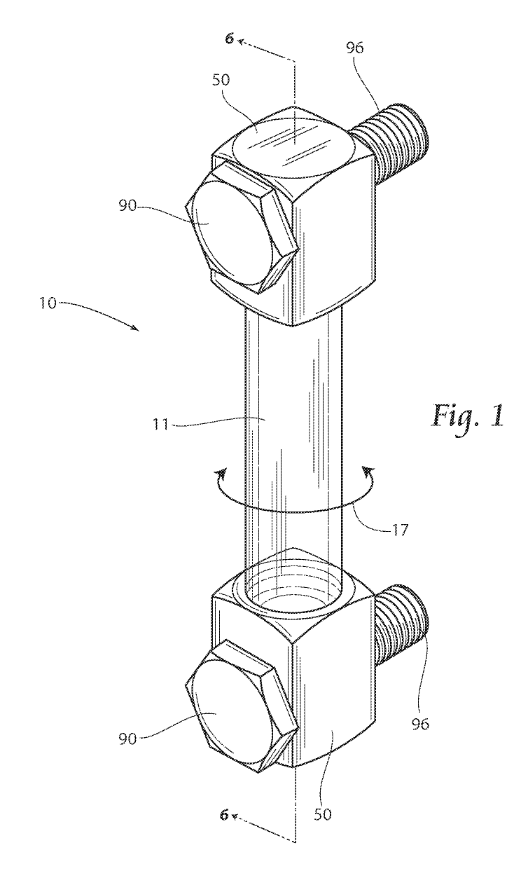

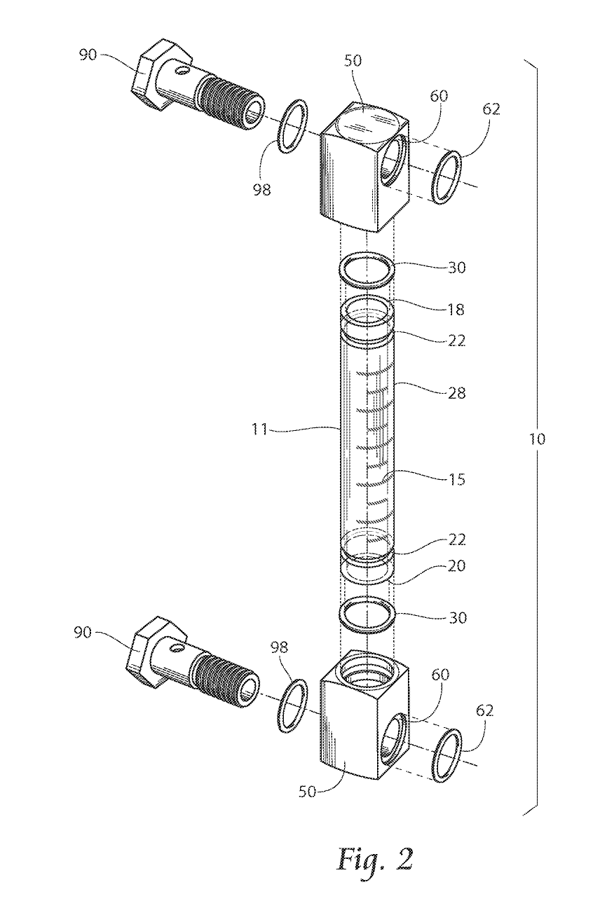

Referring to FIGS. 1 and 2, an embodiment of an improved fluid level verification apparatus 10 according to the present invention is shown. The apparatus 10 preferably comprises an inspection tube 11, a pair of end members or supporting blocks 50, and a pair of mounting bolts 90.

The inspection tube 11 is preferably translucent and more preferably clear. The tube 11 has a first end 18, a second end 20, and grooves 22 within an outer periphery 28 of the tube 11 positioned ac a predetermined distance from the respective tune ends 18, 20. The grooves 22 may be formed in the outer periphery 28 in the inspection tube 11 in a variety of ways. In the preferred embodiment, the grooves 22 are formed in the tube 11 when the tube is molded. Alternatively, and not by limitation, the grooves 22 may be cut, machined and/or milled into the tube 11. In the case of a molded tube 11, indicia 15 may be formed into the tube during the molding process. The indicia may include, but not be limited to, high and/or low level markings, text, gradients, hash marks, etc. In the case of all tubes 11, once installed between the blocks 50, the tube 11 may be rotated as needed. The rotation may occur both prior to and after installation of the verification apparatus 10 (see FIG. 1, arrow 17). This is a benefit of the non-press-fit nature of the junction between each tube end 18,20 and end block 50 as will be explained herein.

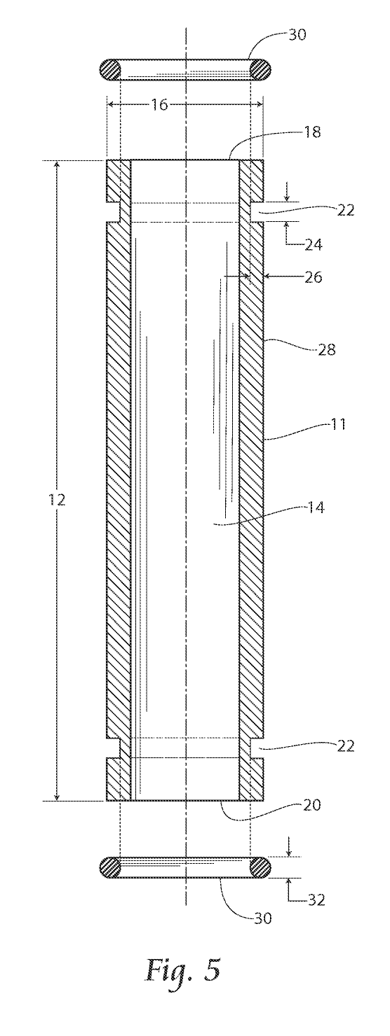

Referring to FIG. 5, a vertical cross section of the inspection tube 11 is shown in detail. The tube 11 is further shown having a tube length 12, a conduit 14, and an outer diameter 16. The grooves 22 each have a respective groove height 24 and groove depth 26. The respective groove depths 26 are selected to accommodate a first seal, such as an o-ring, 30.

As shown in FIG. 5, the o-ring 30 has an o-ring thickness. It is preferable that the groove depth 26 is greater than half the o-ring thickness 32.

The tube 11 may be manufactured from various substrates such as nylon, polycarbonate, or other synthetic materials. While shown to be cylindrical in shape, it is conceivable that other conduit cross-sectional configurations could be utilized.

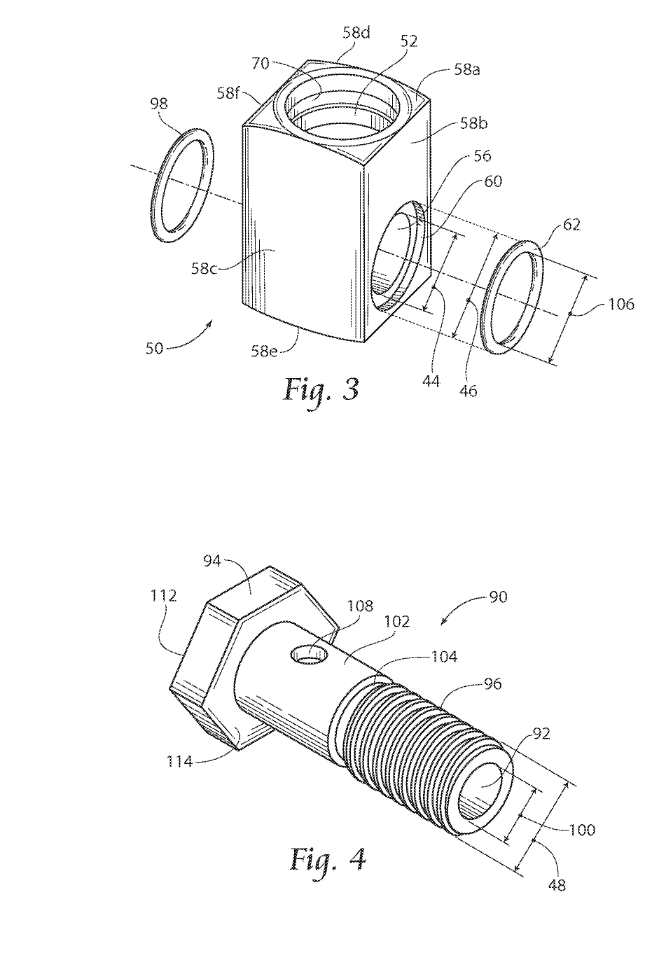

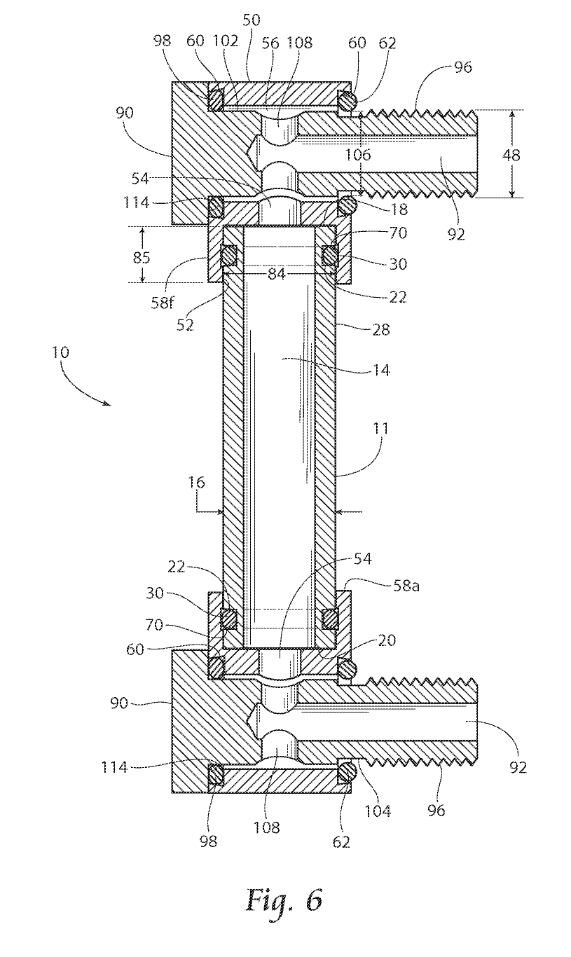

Referring specifically to FIG. 3, each block 50, preferably comprises a plurality of faces 58a, 58b, 58c, 58d, 58e, 58f, a sheathing aperture 52, and a block bore 56. The sheathing aperture 52 has a diameter 84 (see FIG. 6) and extends inward from the block face 58a a depth 85 (see FIG. 6). The sheathing aperture 52 also preferably has a channel 70 located therein as predetermined distance inward, from the block face 58a. In the preferred embodiment, the blocks 50 are symmetrical about a vertical plane as shown in the drawings. While this feature simplifies the assembly of the apparatus 10, non-symmetrical blocks 50 may be utilized as well.

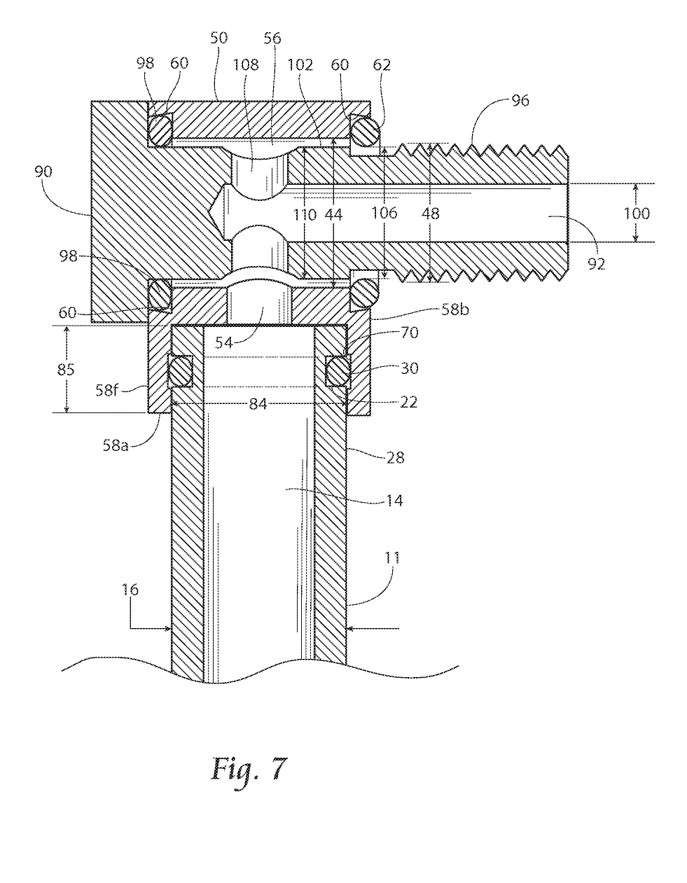

The block bore 56 has an inner diameter 44 and extends from the block face 58b through the block face 58f substantially perpendicular to the sheathing aperture 52. The bore 56 is fluidly connected to the sheathing aperture 52 by a block passageway 54 (see FIG. 7). The bore 56 preferably has a counterbore 60 extending inward from the block faces 58b, 58f and has a counterbore diameter 46. Additionally or alternatively, the counterbore 60 is beveled, increasing in diameter as it extends inwardly from the block faces 58b, 58f. The bevel in counterbore 60 retains the respective seals in the block bore 56 and prevents seal misalignment (e.g. pinching) during installation as will be discussed infra.

Referring to FIG. 6, the first seal 30 is depicted. The first seal 30 is preferably configured to fit within the channel 70 of the sheathing aperture 52 and one of the grooves 22 of the tube 11. In a preferred embodiment, the first seal 30, as well as other seals hereinafter described, may comprise an o-ring made from deformable synthetic material, such as nitrile, fluorocarbon, EPDM, and other similar materials.

With reference to FIGS. 4 and 7 in particular, the bolt 90 comprises a head 94, a bolt shaft 102, a thread with a major diameter 48 provided on at least a portion of the shaft 102, a bolt bore 92 with a bolt bore diameter 100 extending coaxially through the bolt shaft 102, a bolt hole 108 interposed on the bolt shaft 102 substantially perpendicular to and fluidly connected to the bolt bore 92, and a bolt junction 104 intermediate to the bolt hole 108 and the thread 96. The shaft 102 terminates in a bolt head 94. The bolt head 94 has a bolt face 112 and an underside 114. A second seal 98 is positioned between bolt underside 114 of bolt 90 and counterbore 60 in block face 58f. The bolt shaft diameter 110 is preferably smaller than the inner diameter 44 the respective block bore 56 to provide sufficient spacing for free flow of fluid through the bolt bore 92 and the bolt hole 108.

Looking to FIG. 3, a third seal 62 is shown. The seal 62 is sized and configured to be placed in the counterbore 60 and has an inner diameter 106. As shown in FIGS. 6 and 7, the seal 62 preferably creates hermetic closure between the seal 62, the bottom of counterbore 60 and a structure (not shown) on which the apparatus 10 is to be secured. In the preferred embodiment, the seal 62 may comprise an o-ring or similar structure formed from a deformable material such as nitrile, fluorocarbon, EPDM, and other similar materials.

Seals 62 and 98 are retained in beveled counterbores formed on opposite faces 58b and 58f of blocks 50. While seals 62 and 98 are the same size in the preferred embodiment, it should be appreciated that they can be different sizes or diameters.

The assembled apparatus 10 is shown in FIGS. 6 and 7. The first end 18 and second end 20 of the tube 11 are received within the sheathing aperture 52 of respective blocks 50 and the bolts 90 are placed through respective block bores 56. The diameter 84 of the sheathing aperture 52 is narrowly larger than the outer diameter 16 of the inspection tube 11 to provide sufficient spacing for insertion of either ends 18, 20 into the sheathing aperture 52. The depth 85 of the sheathing aperture 52 is preferably deep enough to allow for insertion of the tube 11 into the sheathing aperture 52.

The inspection tube 11 is removably secured to the blocks 50 by the first seal 30 that fits within the channel 70 in the sheathing aperture 52 and simultaneously nests or lodges within the groove 22 of the inspection tube 11. The interface between the first seal 30, the groove 22, and the channel 70 creates a liquid-tight seal to prevent leakage. Based upon the slip fit relationship between the groove 22, the first seal 30, and the channel 70 of the sheathing aperture 52, a hermetic seal or closure is formed with minimal or no mechanical stresses resulting on the inspection tube 11. By greatly decreasing the radial stresses imparted upon the inspection tube 11, the expected life of the tube 11 is thereby increased.

Still referring to FIG. 6, the apparatus 10 is configured to be connected in fluid communication with an object of interest, such as a tank (not shown) by the bolts 90. So connected, the compression exerted on the respective bolts 90 compresses the third seal 98 within the counterbore 60 of the block face 58f of the block 50, thus facilitating a hermetic closure. Similarly, the seal 62 resting on the bolt 90 at the bolt junction 104 is compressed within the counterbore 60 of the block face 58b creating a hermetic seal or closure between the seal 62, the counterbore 60 and the tank (not shown).

Fluid flows between the tank (riot shown) and the tube 11 through the bolt bore 92 and the bolt hole 108 of the bolt 90 and the block bore 56 and the block passageway 54 of the block 50. Fluid enters and fills the conduit 14 of the inspection tube 11 to the liquid level of the tank supporting the inspection tube 11.

Additionally or alternatively, as best shown in FIG. 7, the taper of the counterbore 60 in the block faces 58b, 58f is configured to retain the second and third seals 98,62 within the counterbore 60 and, thus prevent displacement of the second and third seals 98,62 during shipping. The same benefit is derived during installation of the fluid level verification apparatus 10. By positively retaining the second and third seals 98,62 within the counterbore 60 of the block 50, the second and third seals 98,62 will not become fully or partially dislodged during installation.

Also, as best seen in FIG. 6, the major diameter 48 of the bolt threads 6 is greater than the inner diameter 106 of the third seal 62. Once assembled, the resulting interference fit prevents the bolt 90 from becoming dislodged from the block 50, particularly during shipping. The relationship between the bolt threads 96 and the third seal 62 allows the installer to manipulate the apparatus 10 without the bolts 90 falling free from their associated blocks 50. In addition to preventing the loss or separation of parts during shipping and handling, this also prevents the potential pinching of the seal that is likely to occur with a traditional counterbore. As can be readily appreciated, if the seal is not properly positioned within the counterbore, leaking is likely to occur.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I/we claim:

1. A fluid level verification apparatus comprising:
a tube having a first end, a second end opposite the first end, an outer periphery, and a groove provided in the outer periphery inwardly spaced from each of the first end and the second end;
a first and a second end block having a plurality of faces, a block bore extending between opposite faces, a sheathing aperture extending inward from a face adjacent to the block bore and substantially perpendicular to the block bore, and a block passageway providing fluid communication between the sheathing aperture and the block bore;
the block bore having a counterbore on both of the opposing faces;
the sheathing aperture having a recessed channel;
a first and a second mounting bolt each having a bolt head adjoining a bolt shaft with at least one thread, a bolt bore extending coaxially through the bolt shaft, a bolt hole extending through the shaft perpendicular to, and fluidly connected with, the bolt bore, and a bolt junction intermediate to at least one thread and the bolt hole;
the bolt head having an underside nearest the bolt shaft;
the first end of the tube receivable within the sheathing aperture of the first block and the second end of the tube receivable within the second block, wherein the grooves are alignable with the respective channels;
the first and second mounting bolts receivable within and extending through the block bores and configured to be in fluid communication with the tube via the block passageway;
a first seal disposed within the groove in the periphery of the tube and the channel in the sheathing aperture;
a second seal disposed within the counterbore of the block bore and the underside in the bolt head;
a third seal disposed within the counterbore of the block bore opposite the second seal and circumjacent to the bolt junction.

2. The fluid level verification apparatus according to claim 1 for attachment to a tank with an outside surface and containing a fluid, wherein the first and second mounting bolts are attached to the tank and in fluid communication with the fluid in the tank through the bolt bores; and the third seals are in contact with the outside surface of the tank.

3. The fluid level verification apparatus according to claim 1 wherein the counterbores of the block bores are inwardly tapered to retain the second and third seals.

4. The fluid level verification apparatus according to claim 1 where the groove is molded in the tube.

5. The fluid level verification apparatus according to claim 1 where the groove is cut in the tube.

6. The fluid level verification apparatus according to claim 1 where the bolt hole is substantially aligned with the block passageway.

7. The fluid level verification apparatus according to claim 1 where at least one thread on the bolt shaft has a major diameter and the third seal has an inner diameter; and the major diameter of at least one thread is greater than the inner diameter of the third seal.

8. The fluid level verification apparatus according to claim 1 where the first seal is an o-ring with a thickness and the groove has a groove depth; and the groove depth is greater than half the thickness of the o-ring.

9. The fluid level verification apparatus of claim 1 wherein the tube is rotatable.

10. The fluid level verification apparatus of claim 1 wherein indicia is provided on the tube.

11. The fluid level verification apparatus of claim 1 wherein the first and the second end blocks are each symmetrical about a vertical plane.
